(19) United States
(12) Patent Application Publication
(10) Pub. No.: US 2016/0333966 A1
(43) Pub. Date: Nov. 17, 2016

(54) REDUCTION GEAR AND ROBOT

(71) Applicant: Seiko Epson Corporation, Tokyo (JP)

(72) Inventor: Yuya KATAOKA, Chino (JP)

(21) Appl. No.: 15/151,737

(22) Filed: May 11, 2016

(30) Foreign Application Priority Data
May 13, 2015 (JP) 2015-097941

(51) Int. Cl. F16H 1/32

(52) U.S. Cl. CPC F16H 1/32; Y10S 901/25

(57) ABSTRACT

A reduction gear is a reduction gear including a plurality of the inner pins provided in a gear. The inner pin includes a core portion and an outer tube portion mounted on the core portion in an insertion manner, and an elastic modulus of the outer tube portion is less than an elastic modulus of the core portion.

### BACKGROUND

1. Technical Field

The present invention relates to a reduction gear and a robot.

2. Related Art

As a planetary gear type reduction device, a planetary gear type reduction device, which includes cyclo reduction gear and a reduction mechanism similar to the cyclo reduction gear and uses an involute tooth profile fixed sun internal gear (external gear) and a planetary gear (internal gear), is known. In the reduction device of this type, the planetary gear of which the number of teeth is fewer than that of the fixed sun internal gear by one is disposed within the fixed sun internal gear to be rotatable, the planetary gear is eccentrically rotated by high-speed input rotation, and thereby rotation that is significantly decelerated is obtained from aside of an output member that is integrally rotated with a plurality of pins (inner pins) extending through the planetary gear in a loosely fitted state.

Since such a reduction device can realize a large reduction ratio by one stage, the reduction device is employed in a reduction mechanism for high-speed precision control in a driving system of an industrial robot and the like.

However, there may be a backlash that is unacceptable between the fixed sun internal gear and the planetary gear, and the like due to an assembling error, a manufacturing error of the reduction device, and the like. If there is such a backlash, it is undesirable that responsiveness and controllability of the reduction device are reduced.

In addition, a structure of stopping release of a gear support shaft from a support section by hollow pins is disclosed (for example, see JP-A-2014-77247). In addition, a technique, in which a fixed sun internal gear has a two-division structure formed by connecting a first sun internal gear piece and a second sun internal gear piece to each other in an axial direction, and adjustment of the backlash is provided between the fixed sun internal gear and the planetary gear, and between a pin hole and a pin by relatively twisting the first and second sun internal gear pieces in a circumferential direction, is disclosed (for example, see JP-A-5-296301).

However, in the reduction device described in JP-A-2014-77247, the release stop structure using the hollow pins is disclosed, but an elastic modulus and the backlash due to the elastic modulus cannot be reduced. In addition, in the reduction device described in JP-A-5-296301, a clearance between an inner pin and a gear hole needs to be adjusted to zero for eliminating backlash. In addition, there is a concern that the inner pin and the gear hole are excessively too close to each other due to a processing error of parts in some places and then a starting torque is increased.

### SUMMARY

An advantage of some aspects of the invention is to solve at least a part of the problems described above, and the invention can be implemented as the following forms or application examples.

### Application Example 1

A reduction gear according to this application example includes a plurality of inner pins provided in a gear, in which the inner pin includes a core portion and an outer tube portion mounted on the core portion in an insertion manner, and in which an elastic modulus of the outer tube portion is less than an elastic modulus of the core portion.

In this application example, the outer tube portion and the core portion of which an outer diameter is smaller than an inner diameter of the outer tube portion and which is disposed within the outer tube portion are provided, and the elastic modulus of the outer tube portion is less than the elastic modulus of the core portion. Thus, if the gear receives a load, initially, the outer tube portion is bent in a rotating direction by positioning of the outer tube portion. The outer tube portion deformed by a certain degree or more load comes into contact with the core portion on the inside of the outer tube portion. That is, a positioning error is absorbed by the deformation of the outer tube portion and thereby a working tolerance is absorbed and it is possible to reduce backlash. Therefore, it is possible to provide the reduction gear which can achieve both high stiffness and high torque.

In addition, since it is not necessary to reduce the number of arrangements of the inner pins, it is possible to maintain characteristics such as variation of stiffness and service life.

### Application Example 2

In the reduction gear according to the application example, it is preferable that the plurality of outer tube portions are mounted on an outer periphery of the core portion.

According to this application example, the working tolerance is easily absorbed by causing each elastic modulus of the outer tube portions to be different.

### Application Example 3

In the reduction gear according to the application example, it is preferable that the number of the inner pins is equal to or less than 6 sets.

According to this application example, since the number of the inner pins coming into contact with the outer tube portions at a low load is reduced, it is possible to reduce a starting torque. Furthermore, since the number of the inner pins coming into contact with the outer tube portions for positioning is less, it is possible to reduce the number of high-precision parts and to reduce cost.

### Application Example 4

In the reduction gear according to the application example, it is preferable that the number of the inner pins is equal to or less than 4 sets.

According to this application example, since the number of the inner pins coming into contact with the outer tube portions at the low load is reduced, it is possible to further reduce the starting torque. Furthermore, since the number of the inner pins for positioning is decreased, it is possible to reduce the number of high-precision parts and to reduce cost.

### Application Example 5

In the reduction gear according to the application example, it is preferable that an air layer is formed between the core portion and the outer tube portion.

According to this application example, the outer tube portion is easily deformed.

### Application Example 6

A robot according to this application example includes the reduction gear according to any one of the application examples described above.

In this application example, it is possible to provide the robot having high reliability.

### BRIEF DESCRIPTION OF THE DRAWINGS

The invention will be described with reference to the accompanying drawings, wherein like numbers reference like elements.

FIG. 1 is an external view of a reduction gear according to an embodiment.

FIG. 2 is an exploded perspective view illustrating an internal structure of the reduction gear according to the embodiment.

FIG. 3 is an explanatory view illustrating an operation reason of the reduction gear according to the embodiment.

FIG. 4 is an explanatory view illustrating a manner of taking out rotation of a revolution gear by inner pins according to the embodiment.

FIGS. 5A and 5B are sectional views illustrating the revolution gear and the inner pins according to the embodiment, FIG. 5A is a view illustrating an arrangement of the revolution gear and the inner pins, and FIG. 5B is a view illustrating an outline before and after an outer tube portion receives a load.

FIGS. 6A to 6C are diagrams illustrating characteristics of the reduction gear according to the embodiment, FIG. 6A is a diagram illustrating variation of the stiffness and a load of the reduction gear with respect to the number of the inner pins, FIG. 6B is a graph illustrating the stiffness of the reduction gear with respect to an input shaft direction for each number of the inner pins, and FIG. 6C is a graph illustrating the starting torque of the reduction gear with respect to the input shaft direction for each number of the inner pins and for each presence or absence of the outer tube portion.

FIGS. 7A and 7B are explanatory views illustrating a manner of incorporating the reduction gear of the embodiment into joint portions of a robot hand and the like, FIG. 7A is a view illustrating the robot hand, and FIG. 7B illustrates a robot.

### DESCRIPTION OF EXEMPLARY EMBODIMENTS

Hereinafter, an embodiment embodying the invention will be described with reference to the drawings. Moreover, the drawings to be used are displayed by being appropriately enlarged or reduced so that portions to be described are in recognizable states.

### Reduction Gear

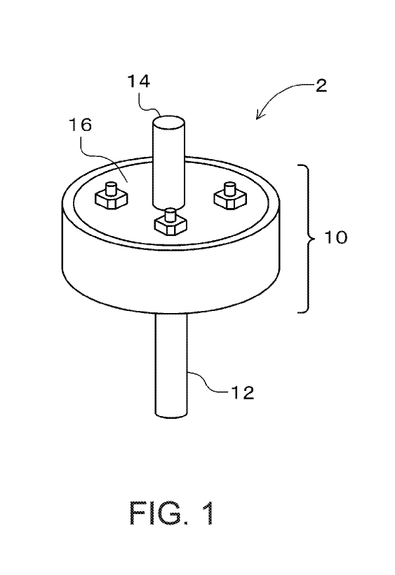

FIG. 1 is an external view of a reduction gear 2 according to the embodiment. As illustrated in the view, an input shaft 12 is provided on a lower surface side of a cylindrical body section 10 in the reduction gear 2 of the embodiment and an output shaft 14 is provided on an upper surface side of the body section 10.

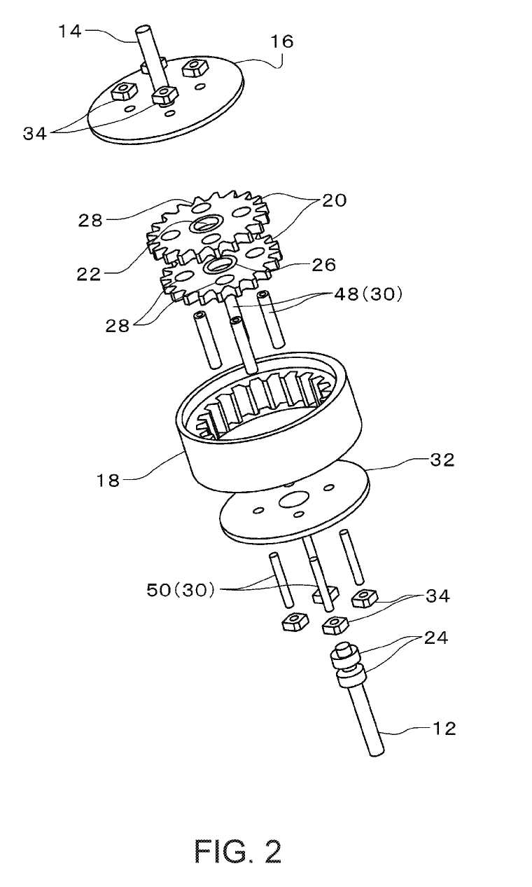

FIG. 2 is an exploded perspective view illustrating an inner structure of the reduction gear 2 according to the embodiment. As illustrated in the view, in the reduction gear 2 of the embodiment, a plurality of gear teeth are formed in an inner periphery (hereinafter, also referred to as an inner peripheral side) of a cylindrical member configuring an outer periphery of the body section 10 and configure a ring gear 18.

In addition, revolution gears 20, of which sizes are smaller than that of the ring gear 18 and in which a plurality of gear teeth are formed in outer peripheries (hereinafter, also referred to as an outer peripheral side), are provided on an inside of the ring gear 18. Shaft holes 22 are provided in a center of the revolution gear 20 and circular cams 24 provided in the input shaft 12 are fitted into the shaft holes 22 via bearings 26 to be rotatable. If the input shaft 12 is rotated in a state in which the body section 10 is fixed, the rotation thereof is reduced by a mechanism within the body section 10 and is output from an upper cover plate 16 or the output shaft 14 fixed to a center of the upper cover plate 16. Moreover, in the reduction gear 2 of the illustrated embodiment, two revolution gears 20 are provided on the inside of the ring gear 18 and a reason thereof will be described later.

In addition, through holes 28 are provided in four positions on a concentric circle of the revolution gear 20 viewed from the center of the revolution gear 20 and an inner pin 30 for taking out movement of rotation of the revolution gear 20 is inserted into each of the through holes 28. A method for taking out the movement of the rotation of the revolution gears 20 by the inner pins 30 will be described later. The inner pins 30 are mounted on the upper cover plate 16 of which an upper end portion configures an upper surface of the body section 10 and are mounted on a lower cover plate 32 of which a lower end portion configures a lower surface of the body section 10. Then, nuts 34 are mounted on end portions of the inner pins 30 protruding from the upper cover plate 16 and the lower cover plate 32 and thereby the inner pins 30 are fixed to the upper cover plate 16 and the lower cover plate 32.

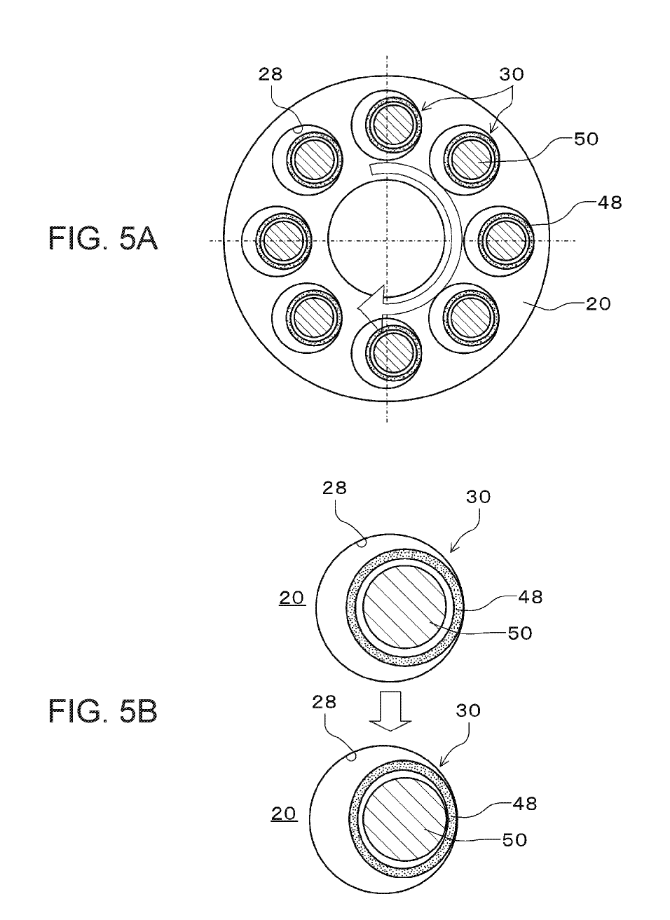

The inner pin 30 includes a core portion 50 and an outer tube portion 48 inserted into the core portion 50 (see FIGS. 5A and 5B). The core portion 50 and the outer tube portion 48 are inserted into the through holes 28 formed in the revolution gears 20. The outer tube portion 48 is positioned between the through hole 28 and the core portion 50, and has elasticity. The upper cover plate 16 and the lower cover plate 32 have connection holes, into which the core portion 50 and the outer tube portion 48 are inserted and connected, output a turn due to rotation of the revolution gear 20, and support the core portion 50 and the outer tube portion 48.

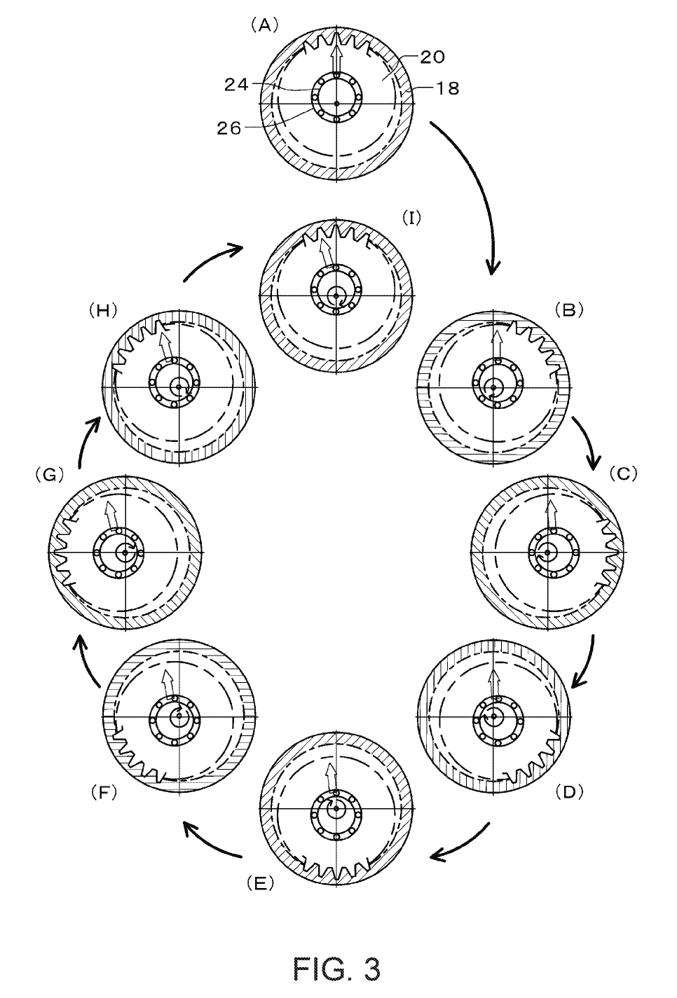

FIG. 3 is an explanatory view illustrating an operation reason of the reduction gear 2 according to the embodiment. As described above with reference to FIG. 2, the revolution gears 20 of which sizes are smaller than that of the ring gear 18 are provided on the inside of the ring gear 18 and the ring gear 18 and the revolution gear 20 mesh with each other. Therefore, the revolution gears 20 are in a state of being eccentric with respect to a center position of the ring gear 18. In addition, the shaft hole 22 (see FIG. 2) is provided in the center of the revolution gear 20 and the circular cam 24 is fitted into the shaft hole 22 via the bearing 26. Therefore, if the input shaft 12 is rotated, the circular cams 24 are rotated and revolution movement is generated in the revolution gears 20 around the input shaft 12 (and a center shaft of the ring gear 18). Moreover, in the embodiment, “revolution” indicates movement of an object around a circumference of a point.

In addition, the turn is able to be performed between the revolution gears 20 and the circular cams 24 by the bearings 26, and the revolution gears 20 and the ring gear 18 are meshed by gear teeth. Therefore, the revolution gears 20 perform revolution around the input shaft 12 (and the center shaft of the ring gear 18) while performing the rotation by meshing of the ring gear 18 with the gear teeth. Moreover, in the embodiment, “revolution” indicates movement rotating around a shaft as a center shaft through a point (for example, a center or a center of gravity) on an inside of an object. For example, in a case of the embodiment, the revolution indicates the movement of rotating the shaft as the center shaft through the center (not illustrated) of the revolution gear 20.

A state, in which the circular cam 24 is eccentric on an upper side in the view and then the revolution gear 20 meshes with the ring gear 18 on the upper side in the view, is illustrated in (A) in FIG. 3. Moreover, an arrow is indicated in a side surface of the revolution gear 20 so that a manner of the turning of the revolution gear 20 can be grasped in FIG. 3. The arrow indicates an upright position in the view in the state of (A) in FIG. 3.

If the input shaft 12 is rotated by 45° from the state illustrated in (A) in FIG. 3 in a clockwise direction, the revolution gear 20 is also revolved by 45° in the clockwise direction by the movement of the circular cam 24. In addition, the revolution gear 20 rotates by an angle corresponding to the number of the gear teeth for meshing with the ring gear in a counterclockwise direction. As a result, the revolution gear 20 enters a state illustrated in (B) in FIG. 3. As is evident from comparison between (A) and (B) in FIG. 3, as the circular cam 24 is turned by 45° in the clockwise direction, the revolution gear 20 is also revolved by 45° in the clockwise direction and is moved to a position eccentric to an upper right side in the view. In addition, orientation of the arrow drawn in the revolution gear 20 indicates the substantially upright position in the view similar to (A) in FIG. 3. It can be considered that the rotation generated in the revolution gear 20 in the counterclockwise direction substantially cancels revolution in the clockwise direction by meshing with the ring gear 18 when the revolution gear 20 is revolved in the clockwise direction.

If the input shaft 12 is rotated by 45° from the state illustrated in (B) in FIG. 3 in a clockwise direction, the revolution gear 20 is moved to a position illustrated in (C) in FIG. 3. This state is a state in which the revolution gear 20 is revolved by 90° in the clockwise direction. In addition, as the revolution gear 20 is revolved to this position while meshing with the ring gear 18, the revolution gear 20 is rotated by an angle corresponding to the number of the gear teeth in the counterclockwise direction. In addition, the direction of the arrow provided in the revolution gear 20 is in a state still indicating the substantially upright position in the view similar to (B) in FIG. 3.

If the input shaft 12 is further rotated from the state illustrated in (C) in FIG. 3 in a clockwise direction, the revolution gear 20 enters a state illustrated in (D) in FIG. 3, a state illustrated in (E) in FIG. 3, a state illustrated in (F) in FIG. 3, a state illustrated in (G) in FIG. 3, and a state illustrated in (H) in FIG. 3, and enters a state illustrated in (I) in FIG. 3 if the input shaft 12 is turned just one revolution. In addition, the arrow direction indicated in the revolution gear 20 is turned by a difference in the number of teeth between the revolution gear 20 and the ring gear 18 in the counterclockwise direction when compared to (A) in FIG. 3. For example, if the number of teeth of the revolution gear 20 is less than the number of teeth of the ring gear 18 by one, the revolution generated in the revolution gear 20 in the clockwise direction and the rotation in the counterclockwise direction have sizes which are substantially cancelled, but strictly speaking, the angle of the rotation is greater than one revolution by one gear tooth. This is because the revolution gear 20 has to be additionally rotated by one revolution in the counterclockwise direction and by one tooth so that the revolution gear 20 is revolved by one revolution in the clockwise direction while meshing with the ring gear 18, as a result of forming the revolution gear 20 of which the number of the gear teeth is less than the number of the gear teeth of the ring gear 18 by one tooth.

As described above, in the reduction gear 2 of the embodiment, if the input shaft 12 is turned by one revolution, the revolution gear 20 is rotated in the opposite direction by the number of the teeth corresponding to the difference in the number of the gear teeth between the revolution gear 20 and the ring gear 18. For example, if the number of the teeth of the ring gear 18 is 50 and the number of the teeth of the revolution gear 20 is 49, the revolution gear 20 is rotated by 1/50 turn (thus, 360°/50=7.2°) in the opposite direction whenever the input shaft 12 is turned by one revolution.

In addition, the movement of the revolution gear 20 when the input shaft 12 is turned can be considered as follows. First, if the input shaft 12 is rotated, the revolution gear 20 is revolved around the input shaft 12 (and the center shaft of the ring gear 18) by the circular cam 24. On the other hand, since the revolution gear 20 meshes with the ring gear 18, the revolution gear 20 is rotated while rolling on the ring gear 18.

Here, the revolution gear 20 is formed slightly smaller than the ring gear 18 in size. Therefore, the revolution gear 20 can roll on the ring gear 18 with only a slight parallel movement almost without actually being turned (exactly, rotation). For example, in the state illustrated in (A) in FIG. 3 and the state illustrated in (B) in FIG. 3, the revolution gear 20 is almost not turned and is only slightly moved in a lower right direction. Nevertheless, a position in which the revolution gear 20 meshes with the ring gear 18 is moved by 45° from the center position of the ring gear 18. That is, the revolution gear 20 rolls on the ring gear 18. In addition, similarly, also in the state illustrated in (B) in FIG. 3 and the state illustrated in (C) in FIG. 3, the revolution gear 20 is almost not turned and is only slightly moved to the right in a substantially lower direction. Nevertheless, the position in which the revolution gear 20 meshes with the ring gear 18 is further moved by 45°. That is, the revolution gear 20 rolls on the ring gear 18.

As described above, if the revolution gear 20 is formed to be only slightly smaller than the ring gear 18, it is possible to roll the revolution gear 20 on the ring gear 18 almost without causing rotation only by moving (swing) the revolution gear 20 to turn the revolution gear 20. Then, only the rotation of an angle corresponding to the difference in the number of the teeth between the ring gear 18 and the revolution gear 20 occurs until the revolution gear 20 is returned to an original position (for example, to the positions illustrated in FIG. 3).

Moreover, as described above, if the input shaft 12 is turned by one revolution, the revolution gear 20 is swung once. This indicates that if the input shaft 12 is turned at a high speed, the revolution gear 20 is vigorously swung and then generation of vibration is a concern. However, as described above, the two revolution gears 20 are provided in the reduction gear 2 of the embodiment (see FIG. 2) and the revolution gears 20 are adapted to revolve shifted to each other by half a cycle. Therefore, the vibration generated due to the swinging of one revolution gear 20 is cancelled by the vibration due to the swinging of the other revolution gear 20 and then it is possible to avoid the generation of the vibration as an entirety of the reduction gear 2.

As described above, even if the revolution gears 20 of the embodiment are revolved, the revolution gears 20 actually only slightly swing the inside of the ring gear 18 while rotating slightly. As described above, it can also be understood that the rotation of the revolution gear 20 is taken out by the inner pins 30. That is, as illustrated in FIG. 2, four through holes 28 are provided in the revolution gear 20 of the embodiment as an example and the inner pin 30 is inserted into each of the through holes 28.

Here, if the size of the through hole 28 is set to be greater than a diameter of the inner pin 30 to a certain degree or more, the movement causing the revolution gear 20 to be swung on the inside of the ring gear 18 is absorbed by a clearance between the through hole 28 and the inner pin 30, and it is possible to take out only the rotation of the revolution gear 20. This will be described below.

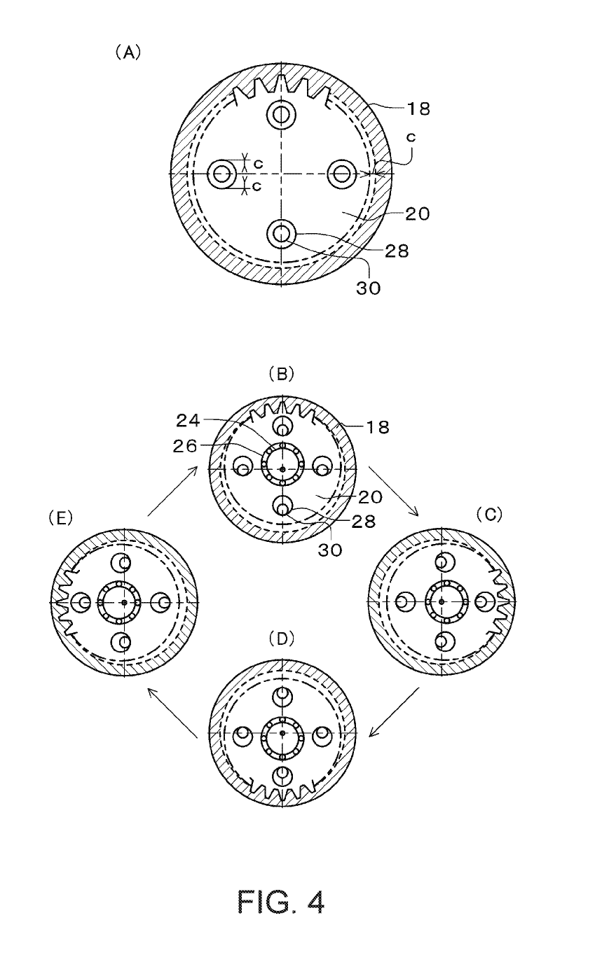

FIG. 4 is an explanatory view illustrating a manner of taking out the rotation of the revolution gear 20 by inner pins 30 according to the embodiment. First the size of the through hole 28 will be described. As illustrated in (A) in FIG. 4, when the center position of the revolution gear 20 is matched with the center position of the ring gear 18, the through hole 28 is superimposed on the position of the inner pin 30 and forms a hole greater than the inner pin 30 by a radius c. Here, “c” is an eccentricity of the revolution gear 20 with respect to the center position of the ring gear 18.

As described above, the revolution gear 20 in which the through holes 28 are formed is eccentric to an upper side on the view by the circular cam 24. Then, since the revolution gear 20 is eccentric in an upward direction by the length c, as illustrated in (B) in FIG. 4, the lower portion of the through hole 28 and an outer periphery of the inner pin 30 are in an abutting state.

In addition, if the revolution gear 20 is eccentric to the right side on the view by the circular cam 24, as illustrated in (C) in FIG. 4, a left portion of the through hole 28 abuts against the inner pin 30. Similarly, if the revolution gear 20 is eccentric to the lower side on the view, as illustrated in (D) in FIG. 4, an upper portion of the through hole 28 abuts against the inner pin 30 and if the revolution gear 20 is eccentric to the left side on the view, as illustrated in (E) in FIG. 4, the through hole 28 abuts against the inner pin 30 on the right side of the through hole 28.

As described above, in the reduction gear 2 of the embodiment, it is possible to absorb the movement causing the revolution gear 20 to be swung on the inside of the ring gear 18 by making the size of the through hole 28 to be greater than that of the inner pin 30 by a size corresponding to the eccentricity c. Moreover, “making the size of the through hole 28 to be greater than that of the inner pin 30 by the size corresponding to the eccentricity c” may be said in other words that the radius of the through hole 28 is greater than the radius of the inner pin 30 by the eccentricity c and may be said in other words that the diameter of the through hole 28 is greater than the diameter of the inner pin 30 by two times (2c) the eccentricity c. On the other hand, if the revolution gear 20 is rotated, since the position of the through hole 28 is moved, the movement is transmitted to the inner pin 30. Therefore, it is possible to take out only the movement of the rotation of the revolution gear 20.

The rotation of the revolution gear 20 that is taken out as described above is transmitted to the upper cover plate 16 and the lower cover plate 32 (see FIG. 2) on which the inner pins 30 are mounted. As a result, the rotation of the revolution gear 20 is output from the output shaft 14 fixed to the upper cover plate 16 to the outside of the reduction gear 2.

Here, as illustrated in (B) to (E) in FIG. 4, the through hole 28 and the inner pin 30 always abuts against each other in one portion and the abutting portion is always moved while the revolution gear 20 is swung on the inside of the ring gear 18. Therefore, if a portion, in which the clearance between the through hole 28 and the inner pin 30 is too small, is present even in any one portion, the through hole 28 and the inner pin 30 are interfered with in the portion and then the reduction gear 2 is in a locked state. Since the occurrence of some manufacturing errors cannot be avoided when manufacturing the through hole 28 and the inner pin 30, in order to avoid such a situation, the clearance between the through hole 28 and the inner pin 30 is required to be largely formed with a margin.

Therefore, in the reduction gear 2 having the operation principle as the embodiment, a gap between the through hole 28 and the inner pin 30 is generated and torque transmission between the through hole 28 and the inner pin 30 is delayed by the gap. Thus, inconvenience, in which a period in which an output torque cannot be obtained is generated or the input shaft 12 is stopped and then the output shaft 14 is rattled, occurs. Thus, in the reduction gear 2 of the embodiment, such inconvenience is suppressed or avoided by employing the structure of interposing the outer tube portion 48 between the through hole 28 and the core portion 50.

FIGS. 5A and 5B are sectional views illustrating the revolution gear 20 and the inner pins 30 according to the embodiment. FIG. 5A is a view illustrating an arrangement of the revolution gear 20 and the inner pins 30 and FIG. 5B is a view illustrating an outline before and after the outer tube portion 48 receives a load. Moreover, the number of the inner pins 30 illustrated in FIG. 5A is eight sets.

As illustrated in FIG. 5A, the inner pin 30 according to embodiment is configured such that the outer tube portion 48 is disposed within the through hole 28 and the core portion 50 is disposed on the inside thereof. The inner pin 30 is provided with the outer tube portion 48 and the core portion 50 of which the outer diameter is smaller than the inner diameter of the outer tube portion 48 and which is disposed within the outer tube portion 48. The elastic modulus of the outer tube portion 48 is less than the elastic modulus of the core portion 50. The core portion 50 may be a pin of which stiffness withstands the maximum load of the reduction gear 2. The outer tube portion 48 is a hollow pin. The core portion 50 may be a solid pin or may be a hollow pin.

If the outer tube portion 48 receives the load in this state, as illustrated in FIG. 5B, the outer tube portion 48 is deformed and comes into contact with the core portion 50. In this state, if the outer tube portion 48 further receives the load from the revolution gear 20, the core portion 50 supports the load. Thus, if the outer tube portion 48 receives a high load, the stiffness that is not changed from the related art is provided. In addition, since positioning accuracy of the reduction gear 2 is determined only by the outer tube portion 48, it is possible to reduce the number of high-precision parts. Furthermore, since a design is performed such that the number of contacts between the core portion 50 and the revolution gear 20 is reduced compared to the related art when receiving a low load, it is possible to reduce the starting torque. In addition, since there is no need to provide a new region for disposing a separate mechanism in the revolution gear 20 without an additional mechanism, it is possible to mount the inner pins 30 without reducing the number of arrangements of the inner pins 30.

A material of the outer tube portion 48 is iron, fluorocarbon resin, rubber, PEEK, or the like. A material of the core portion 50 is required to withstand a high load. For example, the material of the core portion 50 is iron.

Moreover, in this case, the clearance relationship between the outer tube portion 48 and the core portion 50 is provided such that the working tolerance is absorbed and the outer tube portion 48 is not damaged during deformation.

It is preferable that a plurality of outer tube portions 48 are provided on the outer periphery of the core portion 50. Thus, absorption of the working tolerance is facilitated by varying the elastic modulus of each of the outer tube portions 48.

It is preferable that the number of the core portions 50 is equal to or less than six sets. Thus, since the number of the core portions 50 coming into contact with the outer tube portion 48 during a low load is reduced, it is possible to reduce the starting torque. Furthermore, since the number of the core portions 50 coming into contact with the outer tube portion 48 for positioning is reduced, it is possible to reduce the number of the high-precision parts and to reduce cost.

It is preferable that the number of the core portions 50 is equal to or less than four sets. Thus, since the number of the core portions 50 coming into contact with the outer tube portion 48 during a low load is reduced, it is possible to reduce the starting torque. Furthermore, since the number of the core portions 50 coming into contact with the outer tube portion 48 for positioning is reduced, it is possible to reduce the number of the high-precision parts and to reduce cost.

It is preferable that a space (air layer) is provided between the core portion 50 and the outer tube portion 48. Thus, the deformation of the outer tube portion 48 is facilitated.

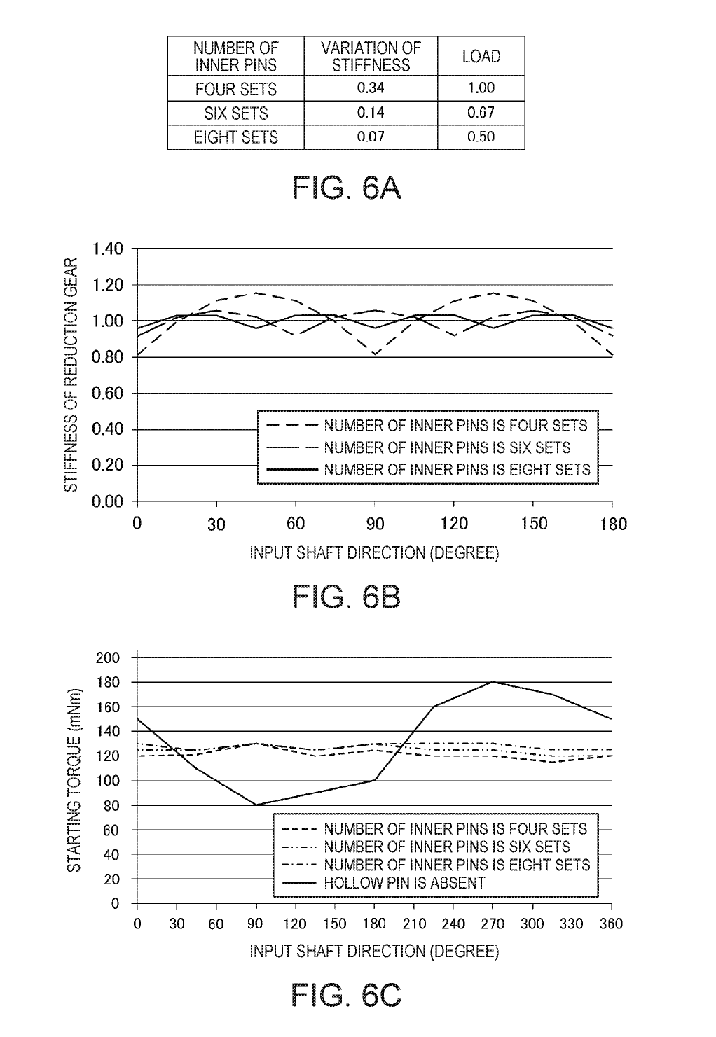

Next, the number of arrangements of the inner pins 30 and characteristics are illustrated in FIGS. 6A to 6C.

FIGS. 6A to 6C are diagrams illustrating the characteristics of the reduction gear 2 according to the embodiment. FIG. 6A is a diagram illustrating variation of the stiffness and the load of the reduction gear 2 with respect to the number of the inner pins 30, FIG. 6B is a graph illustrating the stiffness of the reduction gear 2 with respect to an input shaft direction for each number of the inner pins 30, and FIG. 6C is a graph illustrating the starting torque of the reduction gear 2 with respect to the input shaft direction for each number of the inner pins 30 and for each presence or absence of the outer tube portion 48.

As illustrated in FIG. 6A, the variation of the stiffness of the reduction gear 2 is reduced as the number of the inner pins 30 is increased. In addition, the load of the reduction gear 2 is reduced by dispersion of the load as the number of the inner pins 30 is increased.

As illustrated in FIG. 6B, the variation of the stiffness of the reduction gear 2 with respect to the input shaft direction is reduced as the number of the inner pins 30 is increased.

As illustrated in FIG. 6C, the variation of the starting torque of the reduction gear 2 is reduced compared to variation of a starting torque of a reduction gear in which outer tube portions are not present of the related art. In addition, the number of the inner pins 30 is increased and thereby the variation of the starting torque is reduced.

According to the embodiment, the outer tube portion 48 and the core portion 50 of which the outer diameter is smaller than the inner diameter of the outer tube portion 48 and which is disposed within the outer tube portion 48 are provided, and the elastic modulus of the outer tube portion 48 is less than the elastic modulus of the core portion 50. Thus, if the revolution gear 20 receives a load, initially, the outer tube portion 48 is bent in the rotating direction by positioning of the outer tube portion 48. The outer tube portion 48 deformed by a certain degree or more load comes into contact with the core portion 50 on the inside of the outer tube portion 48. That is, the positioning error is absorbed by the deformation of the outer tube portion 48 and thereby the working tolerance is absorbed and it is possible to reduce the backlash. Therefore, it is possible to provide the reduction gear 2 which can achieve both high stiffness and high torque.

In addition, since it is not necessary to reduce the number of arrangements of the core portions 50, it is possible to maintain characteristics such as the variation of the stiffness and service life.

Since the positioning error is absorbed by the deformation of the outer tube portion 48, the working tolerance is absorbed and it is possible to reduce the backlash by positioning of the outer tube portion 48.

Since the number of the inner pins 30 coming into contact with the revolution gear 20 for positioning is reduced, it is possible to reduce the number of the high-precision parts and to reduce the cost.

Since the number of the core portions 50 coming into contact with the outer tube portions 48 during the low load is reduced it is possible to reduce the starting torque.

Since it is not necessary to reduce the number of arrangements of the inner pins 30, it is possible to maintain characteristics such as the variation of the stiffness and the service life.

Moreover, the elastic modulus of the plurality of outer tube portions 48 may be constant. In addition, the elastic modulus of the plurality of core portions 50 may be constant.

In addition, in this structure, adjustment is not required and reduction of the driving torque can be achieved by absorbing the working tolerance by having a plurality of diameters of the inner pins 30.

Furthermore, the outer tube portion 48 is disposed on the inside of the outer tube portion 48 and the core portion 50 may be further disposed on the inside thereof. In this case, the number of stages of the outer tube portions 48 may be any number.

### Robot

As described above, the reduction gear 2 of the embodiment can realize a large reduction ratio and it is possible to prevent delay of an output and rattling of the output shaft 14. Therefore, the reduction gear 2 of the embodiment is particularly suitable as a reduction gear mounted on a portion where a precise operation is required such as a joint of a robot hand.

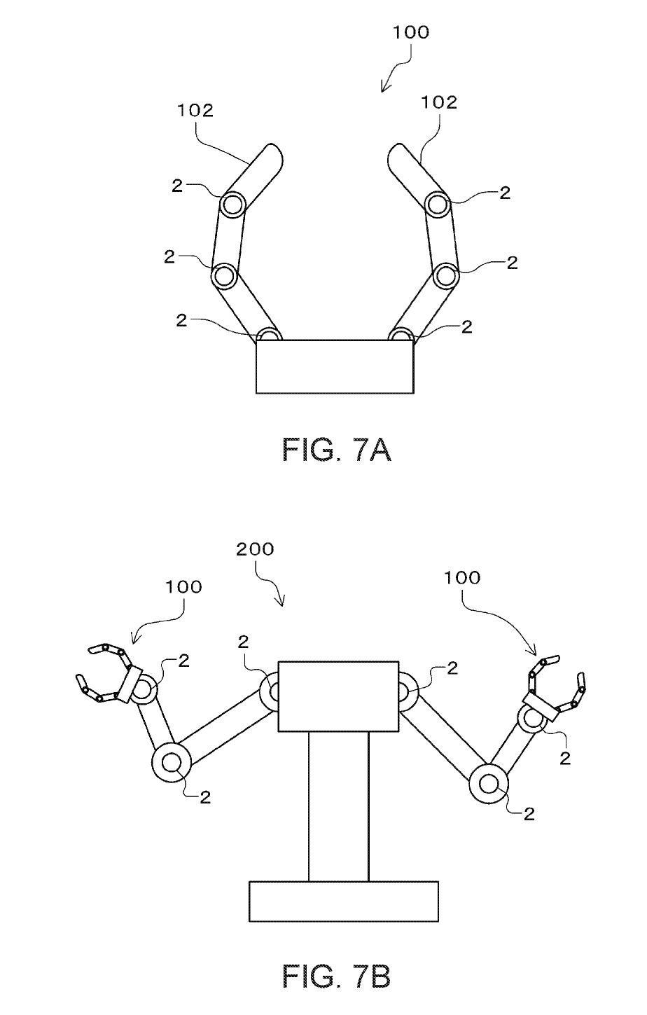

FIGS. 7A and 7B are explanatory views illustrating a manner of incorporating the reduction gear 2 of the embodiment into joint portions of a robot hand and the like. The joints are provided in three portions of each of two fingers 102 facing each other and the reduction gear 2 is incorporated in the joint portion in a robot hand 100 illustrated in FIG. 7A. In addition, in a robot 200 illustrated in FIG. 7B, the reduction gear 2 is incorporated in a connection section between an arm portion of the robot and the robot hand 100, an elbow portion of the arm portion, a root portion of the arm portion, or the like. Thus, the delay of the output of the joint portion in which the reduction gear 2 is incorporated and rattling of the output shaft 14 are prevented and it is possible to smooth the movement of the joint.

The reduction gear and the robot of the embodiment are described above, but the invention is not limited to the above-described embodiment and can be embodied in various forms without departing from the scope of the invention.

The entire disclosure of Japanese Patent Application No. 2015-097941, filed May 13, 2015 is expressly incorporated by reference herein.

What is claimed is:

1. A reduction gear comprising:
a plurality of inner pins provided in a gear,
wherein the inner pin includes a core portion and an outer tube portion mounted on the core portion in an insertion manner, and
wherein an elastic modulus of the outer tube portion is less than an elastic modulus of the core portion.

2. The reduction gear according to claim 1,
wherein a plurality of outer tube portions are mounted on an outer periphery of the core portion.

3. The reduction gear according to claim 1,
wherein the number of the inner pins is equal to or less than 6 sets.

4. The reduction gear according to claim 1,
wherein the number of the inner pins is equal to or less than 4 sets.

5. The reduction gear according to claim 1,
wherein an air layer is formed between the core portion and the outer tube portion.

6. A robot comprising:
the reduction gear according to claim 1.

7. A robot comprising:
the reduction gear according to claim 2.

8. A robot comprising:
the reduction gear according to claim 3.

9. A robot comprising:
the reduction gear according to claim 4.

10. A robot comprising:
the reduction gear according to claim 5.
